(19) United States
(12) Patent Application Publication
(10) Pub. No.: US 2009/0243390 A1
(43) Pub. Date: Oct. 1, 2009

(54) POWER SUPPLY APPARATUS AND POWER CONTROL METHOD

(75) Inventor: Katsuya Oto, Asaka-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/393,876

(22) Filed: Feb. 26, 2009

(30) Foreign Application Priority Data
Mar. 25, 2008 (JP) 2008-078737

(51) Int. Cl. H02J 1/00

(52) U.S. Cl. 307/43

(57) ABSTRACT

According to one embodiment, a power supply apparatus comprises a DC/DC converter coupled to an output of a fuel cell, a first diode connected between the output of the DC/DC converter and an output terminal of the apparatus, a second diode connected between an output of a secondary battery and the output terminal, a first transistor connected in parallel with the first diode, a second transistor connected in parallel with the second diode, and a control module configured to set the first and the second transistor to the off and the on state, respectively, when the output voltage of the DC/DC converter is equal to or lower than a reference voltage, and to set the first and the second transistor to the on and the off state, respectively, when the output voltage of the DC/DC converter is higher than the reference voltage.

### CROSS-REFERENCE TO RELATED APPLICATIONS

This application is based upon and claims the benefit of priority from Japanese Patent Application No. 2008-078737, filed Mar. 25, 2008, the entire contents of which are incorporated herein by reference.

### BACKGROUND

1. Field

One embodiment of the present invention relates to a power supply apparatus for use in electronic equipment, such as a personal computer, and a method of control thereof, and more particularly to a power supply apparatus which uses a fuel cell as a power source and a method of control thereof.

2. Description of the Related Art

Heretofore, a lithium ion battery has been used as a power source in portable electronic equipment, such as a notebook computer. Recently, in portable electronic equipment as well, a fuel cell has received attention as a new power source which replaces the lithium ion battery.

A fuel cell adapted for use in portable electronic equipment requires reduction in size. For this reason, it is required to keep the power-producing capability of the fuel cell relatively low.

In view of such requirements, a system has been recently developed which uses both the output power of a fuel cell and the output power of a secondary battery.

Jpn. Pat. Appln. KOKAI Publication No. 2005-346984 discloses a system which uses both a fuel cell and a secondary battery. In this system, the output of the fuel cell and the output of the secondary battery are coupled through a diode-based OR circuit to the load.

However, the system does not take into consideration power loss attributed to the diode OR circuit. To implement a small-sized electric power unit which uses a fuel cell, it is necessary to realize a new function capable of reduce this power loss.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a power supply apparatus according to an embodiment of the invention;

FIG. 2 is an exemplary view showing the output characteristic of a DC/DC converter provided in the power supply apparatus shown in FIG. 1;

FIG. 3 is an exemplary view showing on/off control conditions of each of the two FETs provided in the power supply apparatus shown in FIG. 1;

FIG. 4 is an exemplary timing diagram for use in explanation of the on/off control operations of the two FETs carried out by the electric power unit shown in FIG. 1; and

FIG. 5 is an exemplary block diagram showing a fuel cell unit including the power control circuit provided in the electric power unit shown in FIG. 1.

### DETAILED DESCRIPTION

Various embodiments according to the invention will be described hereinafter with reference to the accompanying drawings. In general, according to one embodiment of the invention, there is provided a power supply apparatus comprising: a DC/DC converter coupled to an output of a fuel cell, and configured to have a characteristic such that an output voltage of the DC/DC converter drops with increasing an output current of the DC/DC converter; a first diode connected between the output of the DC/DC converter and an output terminal of the apparatus; a second diode connected between an output of a secondary battery and the output terminal, the second diode having the same forward voltage drop as that of the first diode; a first transistor which has a current path connected in parallel with the first diode; a second transistor which has a current path connected in parallel with the second diode; and a control module configured to monitor the output voltage of the DC/DC converter and the output voltage of the secondary battery, to set the first and the second transistor to the off and the on state, respectively, when the output voltage of the DC/DC converter is equal to or lower than a reference voltage which is the sum of the output voltage of the secondary battery and a given offset voltage, and to set the first and the second transistor to the on and the off state, respectively, when the output voltage of the DC/DC converter is higher than the reference voltage, the offset voltage being equal to the forward voltage drop or higher than the forward voltage drop by a given value.

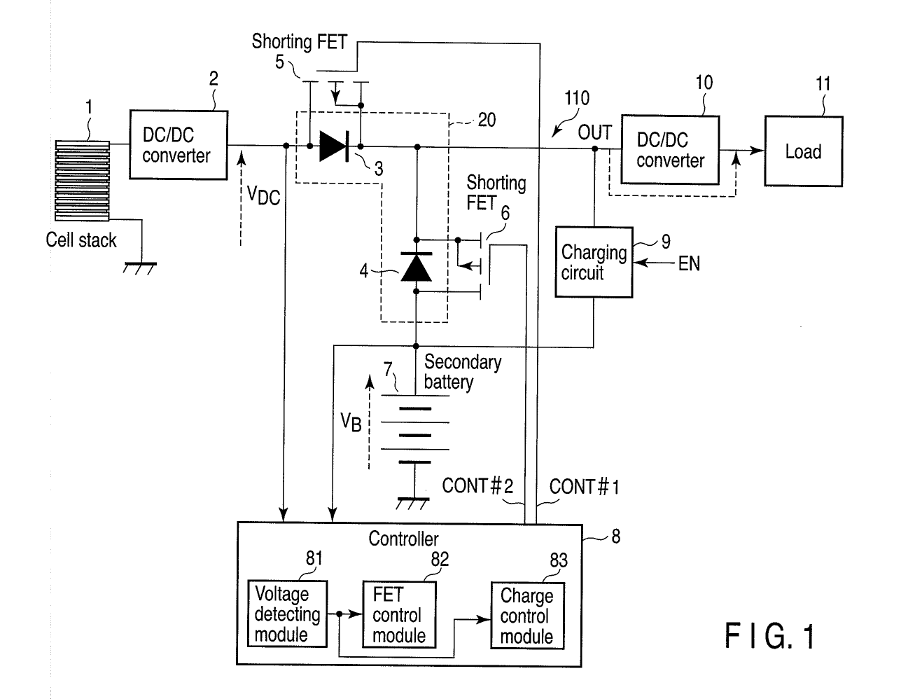

Reference is now made to FIG. 1 to describe the configuration of a power supply apparatus according to an embodiment of the invention. The power supply apparatus is an electric power unit is used as a power source of potable electronic equipment, such as a personal computer. The power unit is configured to produce electric power to be supplied to electronic equipment as a load 11 from a fuel cell (fuel cell stack) 1 and a secondary battery 7.

The fuel cell 1 is comprised of a fuel cell stack, such as a DMFC (direct methanol fuel cell) stack. The fuel cell 1 has a feature that its output voltage drops with increasing its output current. For this reason, the output power of the fuel cell takes a peak value when its output current is a given value. The secondary battery 7 is a battery which can be charged over and over.

The electric power unit has a cell stack output mode and a hybrid output mode as operation modes for producing power from the fuel cell 1 and the secondary battery 7.

The cell stack output mode is one to supply power to the load 11 using only the output power of the fuel cell 1. This mode is used mainly when the power consumption of the load 11 is relatively small (the load is low). At the low-load time, the excess power of the fuel cell 1 is also used to charge the secondary battery 7.

The hybrid output mode is one to supply power to the load 11 using the output power of both the fuel cell 1 and the secondary battery 7. This mode is used when the power consumption of the load 11 is large (the load is high). With electronic equipment, such as a computer, the peak power consumption is much higher than the average power consumption. For this reason, at the high-load time when the peak power consumption is high, the power consumption of the load 11 exceeds the power produced by the fuel cell 1 and hence the fuel cell 1 alone cannot supply sufficient power to the load 11. To compensate for the shortage of power at the high-load time, the hybrid output mode is used to produce sufficient power to be supplied to the load 11 from both the fuel cell 1 and the secondary battery 7. The electric power unit of this embodiment is automatically switched between the cell stack output mode and the hybrid output mode according to conditions of the load 11.

To implement the operation corresponding to each of the cell stack output mode and the hybrid output mode, the electric power unit is equipped with a first DC/DC converter 2, a first diode 3, a second diode 4, a first transistor (shorting FET) 5, a second transistor (shorting FET) 6, a controller 8, a charging circuit 9, and a second DC/DC converter 10. These components function as a power supply control circuit 110 to produce power in the cell stack output mode or the hybrid output mode.

The first DC/DC converter 2 has its input coupled to the output of the fuel cell 1. To maintain the output power of the fuel cell 1 constant, this DC/DC converter 2 is configured to have a control characteristic such that its output voltage falls with increasing its output current.

That is, as described above, the fuel cell 1 has a characteristic such that its output voltage drops with increasing its output current. For this reason, the output power of the fuel cell 1 takes a peak value when its output current is a given value. To obtain power from the fuel cell 1 in an efficient manner, the first DC/DC converter 2 operates in the constant-power input control mode for making the output power of the fuel cell 1 substantially constant. As a result, the first DC/DC converter 2 has a characteristic such that its output voltage drops as its output current increases.

In the first DC/DC converter 2, the duty ratio of a pulse width modulation signal for switching control of a switching device (FET) in the converter is controlled according to the output current or voltage of the fuel cell 1 so that the output power of the fuel cell becomes substantially constant. For example, in performing constant-power input control using the output current of the fuel cell 1, the first DC/DC converter 2 simply detects the output current of the fuel cell 1 and controls the duty ratio of the pulse width modulation signal according to the difference between the detected output current and a reference current so that the output current of the fuel cell 1 and the reference current coincide with each other.

The first diode 3 is connected between the output of the first DC/DC converter 2 and the output terminal OUT of the power unit. That is, the first diode 3 has its anode connected to the output of the first DC/DC converter 2 and its cathode connected to the power unit output terminal OUT.

The second diode 4 is connected between the output of the secondary battery 7 and the power unit output terminal OUT. That is, the second diode 4 has its anode connected to the output of the secondary battery 7 and its cathode connected to the power unit output terminal OUT. The forward voltage drop VF across the second diode 4 is the same as that across the first diode 3.

The first and second diodes 3 and 4 form a diode OR circuit 20. This diode OR circuit 20 is used to connect the first DC/DC converter 2 and the secondary battery 7 in common to the output terminal OUT while preventing reverse flow of current (flow of current from the first DC/DC converter 2 into the secondary battery 7 and from the secondary battery 7 into the first DC/DC converter 2).

The output voltage of the first DC/DC converter 2 when its output current is a given value or less is higher than that of the secondary battery 7. Therefore, at the low-load time, that is, when the output current of the first DC/DC converter 2 is the given value or less, the output voltage of the first DC/DC converter 2 is higher than that of the secondary battery 7, causing the second diode 4 to be reverse biased. Consequently, only the output current of the first DC/DC converter 2 is supplied to the load 11 (the cell stack output mode).

When the power consumption of the load 11 increases, the output voltage of the first DC/DC converter 2 starts to drop. When the output voltage of the first DC/DC converter 2 drops to a certain value, the second diode 4 is biased in the forward direction, which allows the output currents of both the first DC/DC converter 2 and the secondary battery 7 to be supplied to the load 11 (the hybrid output mode).

However, the presence of the first and second diodes 3 and 4 leads to power loss due to the forward voltage drop across each of them.

This embodiment is equipped with the first and second transistors (shorting FETs) 5 and 6 to reduce the power loss attributed to the diode OR circuit 20. The shorting FET 5 is connected to bypass the first diode 3 and its current path between the source and the drain is connected in parallel with the first diode 3. The shorting FET 6 is connected to bypass the second diode 4 and its current path between the source and the drain is connected in parallel with the second diode 4. In this embodiment, these shorting FETs 5 and 6 are on/off controlled interlocked with switching of the operation modes (the cell stack output and hybrid output modes) of the electric power unit.

To on/off control each of the shorting FETs 5 and 6 in synchronization with switching of the operation modes of the electric power unit, the controller 8 monitors the output voltage VDC of the first DC/DC converter 2 and the output voltage VB of the secondary battery 7. This is because the electric power unit is automatically switched between the cell stack output mode and the hybrid output mode by the action of the diode OR circuit 20 in accordance with the relation between the output voltage VDC of the first DC/DC converter 2 and the output voltage VB of the secondary battery 7.

The controller 8 makes a decision of whether or not the output voltage VDC of the first DC/DC converter 2 and the output voltage VF of the secondary battery 7 satisfy the relation indicated by the following expression:

VDC≦Vof+VB (1)

where Vof is a predetermined offset voltage.

Vof is preset to a value equal to the forward voltage drop VF (Vof=VF) or a value which is slightly higher than VF (Vof.=VF+α). That is, Vof satisfies the relation that Vof≧VF.

In this embodiment, the voltage given by Vof+VB is referred to as the reference voltage. That is, the reference voltage is obtained by adding the offset voltage Vof, which is equal to or slightly higher than the forward voltage drop VF, to the output voltage VB of the secondary battery. This reference voltage can be considered as the boundary value to cause the electric power unit to make the transition from the cell stack output mode to the hybrid output mode, and vice versa.

Upon detecting that the output voltage VDC of the first DC/DC converter 2 is higher than the reference voltage (Vof+VB), the controller 8 sets the shorting FET 5 to the on state and the shorting FET 6 to the off state. When the output voltage VDC of the first DC/DC converter 2 is the reference voltage (Vof+VB) or less, on the other hand, the controller 8 sets the shorting FET 5 to the off state and the shorting FET 6 to the on state.

A description is given here of control of the FETs 5 and 6 which is carried out at the transition from the low-load state to the high-load state. Assume here that Vof=VF, that is, the reference voltage is VF+VB.

In the low-load state, the output voltage VDC of the first DC/DC converter 2 is higher than VF+VB. Therefore, the FET 5 is in the on state, while the FET 6 is in the off state.

When the load current dissipated by the load 11 increases, the output voltage VDC of the first DC/DC converter 2 starts to drop. Suppose that the output voltage VDC of the first DC/DC converter 2 has fallen to VF+VB (VDC=VF+VB). Since the FET 5 is still placed in the on state, the voltage on the output terminal OUT is VDC (VDC=VF+VB). The controller 8 turns off the FET 5. As a result, the voltage on the output terminal OUT becomes lower than VDC by the voltage drop VF across the diode 3, i.e., VDC−VF. Since VDC=VF+VB, the voltage on the output terminal OUT becomes equal to VB. The controller 8 turns on the FET 6. Thereby, the electric power unit makes the transition from the cell stack output mode to the hybrid output mode.

Next, on the assumption that Vof=VF+α, that is, the reference voltage is VF+VB+α, a description is given of control of the FETs 5 and 6 which is carried out at the transition from the low-load state to the high-load state.

When the load current dissipated by the load 11 increases, the output voltage VDC of the first DC/DC converter 2 starts to drop. Suppose that the output voltage VDC of the first DC/DC converter 2 has fallen to VF+VB+α (VDC=VF+VB+α). Since the shorting FET 5 is still in the on state, the voltage on the output terminal OUT is VDC (VDC=VF+VB+α). The controller 8 turns off the FET 5. Thereby, the voltage on the output terminal OUT becomes VDC−VF due to the voltage drop across the diode 3. That is, the voltage on the output terminal OUT becomes VB+α. The controller 8 turns on the FET 6, thereby allowing the secondary battery 7 to start to be charged. This charging causes the output current of the DC/DC converter 2 to increase and its output voltage to lower. Thus, the electric power unit makes the transition from the cell stack output mode to the hybrid output mode.

The charging circuit 9 is connected between the power unit output terminal OUT and the secondary battery 7. This charging circuit 9 is configured to charge the secondary battery 7. The charging circuit 9 is set to the active state or the inactive state in response to an enable signal EN from the controller 8.

Furthermore, the second DC/DC converter 10 may be connected to the power unit output terminal OUT. This DC/DC converter 10 is adapted to convert the output voltage on the output terminal OUT to a target voltage of a constant value and comprised of a stepup/stepdown switching regulator which is capable of boosting or lowering the voltage on the output terminal OUT. The second DC/DC converter allows a constant power supply voltage to be supplied to the load 11. Of course, the output voltage on the output terminal OUT of the power unit may be directly supplied to the load 11.

The configuration of the controller 8 will be described next.

The controller 8 is equipped with a voltage detecting module 81, a FET controller 82, and a charge controller 83. The voltage detecting module 81 is connected to the outputs of the first DC/DC converter 2 and the secondary battery 7 to detect their respective output voltages VDC and VB.

The FET controller 82 controls the generation of FET control signals CONT#1 and CONT#2 in response to the result of detection of the output voltages VDC and VB by the voltage detecting module 81. The FET control signal CONT#1 is applied to the gate of the shorting FET 5 to turn it on or off. Likewise, the FET control signal CONT#2 is applied to the gate of the shorting FET 6 to turn it on or off.

The FET controller 82 determines whether or not the output voltages VDC and VB satisfy the relation that VDC≦Vof+VB, that is, the output voltage VDC is the reference voltage (=Vof+VB) or less. If the output voltage VDC is higher than the reference voltage, then the FET controller 82 sets the FET 5 to the on state and the FET 6 to the off state. If, on the other hand, VDC is the reference voltage or less, then the FET controller 82 sets the FET 5 to the off state and the FET 6 to the on state.

The charge controller 83 controls the charging circuit 9 in accordance with the output voltage VDC. That is, the charging controller 83 applies an enable signal EN to the charging circuit 9 to control it when the output voltage VDC is equal to or higher than a predetermined voltage higher than the reference voltage. When a small load current is dissipated by the load 11, the output voltage VDC is relatively high. At such a time, the charge controller 83 operates the charging circuit 9.

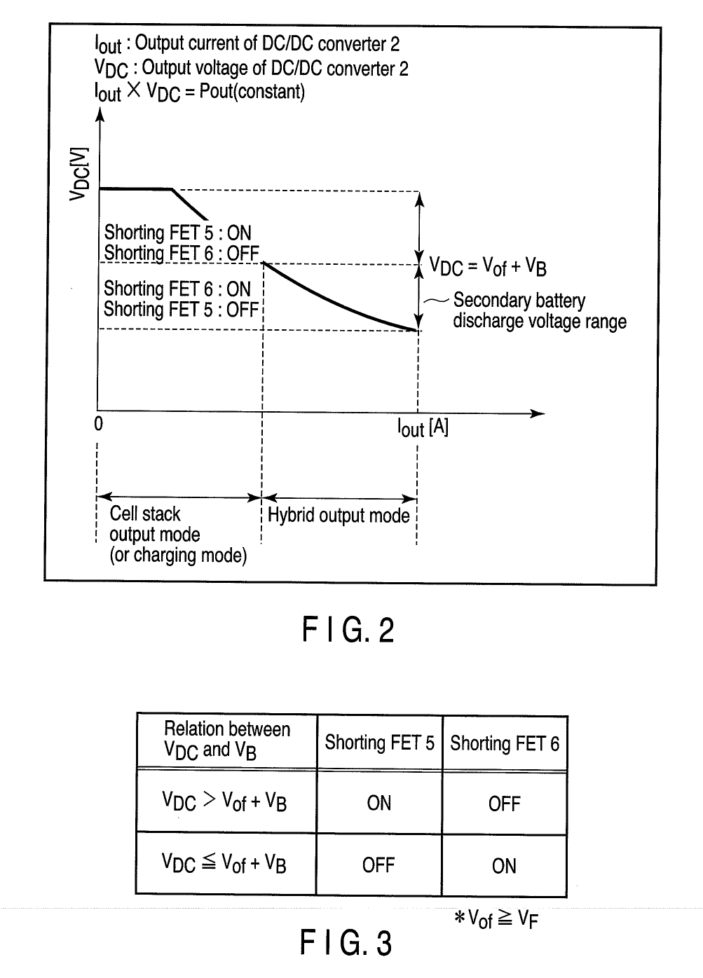

Reference is next made to FIG. 2 to describe the control characteristic of the first DC/DC converter 2. FIG. 2 shows the output voltage versus output current static characteristic of the first DC/DC converter 2 and the operation modes of the electric power unit of the embodiment.

As described above, to efficiently take power out of the fuel cell 1, the first DC/DC converter 2 controls the output voltage or current of the fuel cell 1 to a constant value to keep its output power nearly constant (constant power input control). For this reason, as the output current Iout of the first DC/DC converter 2 increases, its output voltage VDC lowers. However, the constant power input control is not carried out when the output current Iout is relatively small because it is required to set up an upper limit on the output voltage VDC. Because of the aforementioned features, the DC/DC converter 2 will have such an Iout−VDC characteristic as shown in FIG. 2.

At the low-load time, that is, when the output voltage VDC is higher than the reference voltage (=Vof+VB), the electric power unit operates in the cell stack output mode (or the charging mode in which the secondary battery 7 is charged by the charging circuit 9). In this mode, the FET 5 is turned on and the FET 6 is turned off as shown in FIG. 3. In this cell stack output mode, the diode 4 is reverse biased, thus preventing output current from flowing from the secondary batter 7. Therefore, the charging circuit 9 is allowed to charge the secondary battery 7. On the other hand, the diode 3 is bypassed by the FET 5, thus preventing the occurrence of power loss due to the voltage drop across the diode 3. The charging of the secondary battery 7 by the charging circuit 9 is carried out when the output voltage VDC is a given value higher than the reference voltage (=Vof+VB), for example, when VDC is a value in the vicinity of its upper limit value.

At the high-load time when the peak power consumption increases, that is, when the output voltage VDC is equal to or lower than the reference voltage, the electric power unit operates in the hybrid output mode. In this mode, the FET 5 is turned off and the FET 6 is turned on as shown in FIG. 3. In the hybrid output mode, the diode 4 is bypassed by the FET 6, thus preventing the occurrence of power loss attributed to the voltage drop across the diode 4. The output voltage VDC changes so as to follow the change in the output voltage VB of the secondary battery 7.

In this embodiment, an interval when the FETs 5 and 6 are simultaneously turned off is set up at the transition from one operation mode to the other, thereby controlling these FETs so that they are not simultaneously turned on.

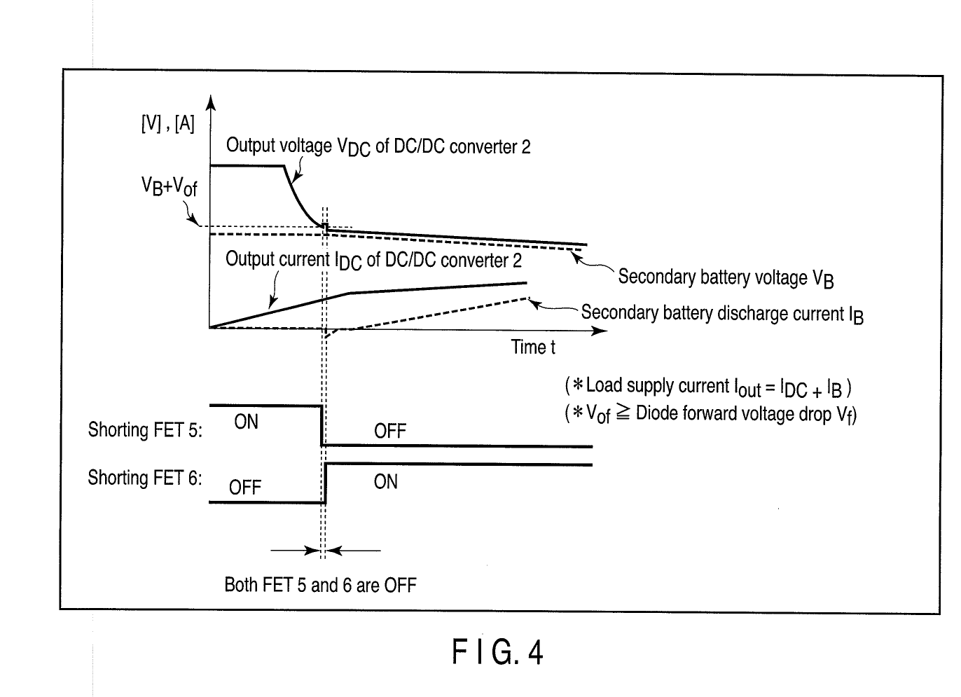

FIG. 4 shows the timing of switching control of the FETs 5 and 6 at the transition from the cell stack output mode to the hybrid output mode.

The controller 8 monitors the output voltage VDC of the first DC/DC converter 2 and the output voltage VB of the secondary battery 7 in the state where the FETs 5 and 6 have been turned on and off, respectively.

When the output voltage VDC of the first DC/DC converter 2 drops to the reference voltage (Vof+VB), the controller 8 switches the FET 5 from the on state to the off state and then switches the FET 6 from the off state to the on state. Thereby, both the output current (IDC) of the first DC/DC converter 2 and the output current (discharge current) of the secondary battery 7 are supplied to the load 11. The load current IOUT supplied to the load 11 becomes IDC+IB.

After that, the controller 8 continues to monitor the output voltage VDC of the first DC/DC converter 2 and the output voltage VB of the secondary battery 7. When the output voltage VDC of the first DC/DC converter 2 rises above the reference voltage (Vof+VB) as the load current decreases, the controller 8 switches the FET 6 from the on state to the off state and then switches the FET 5 from the off state to the on state.

By the above operation, one of the OR-connected diodes 3 and 4 can be shorted (bypassed) properly and safely, thus allowing the prevention of occurrence of power loss due to the forward voltage drop across the diode.

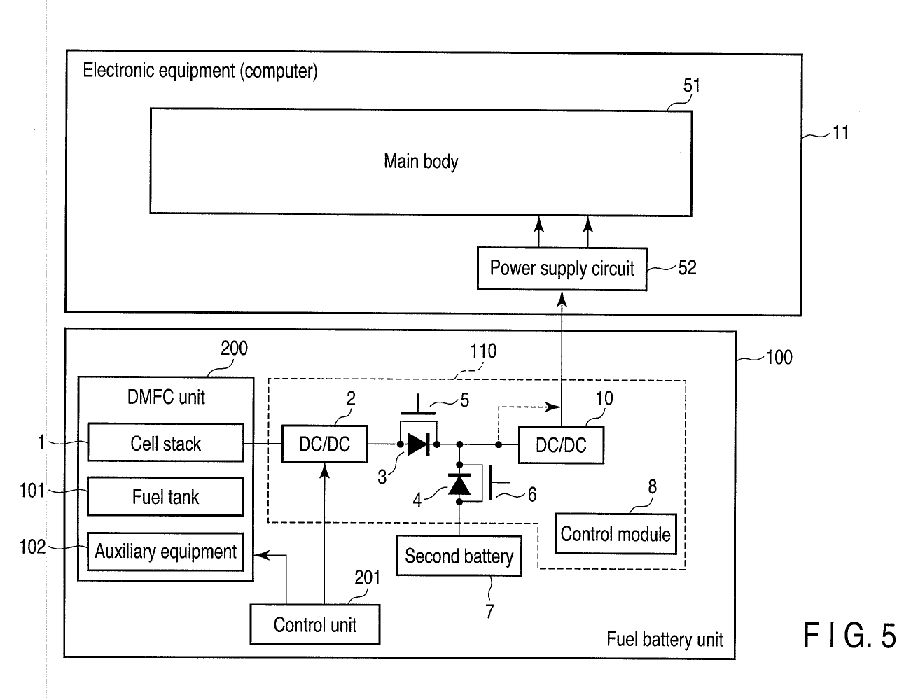

FIG. 5 shows one example of a fuel cell unit which comprise the power supply control circuit 110 of the electric power unit of the embodiment.

The fuel cell unit 100 functions as an external power source which supplies power to portable electronic equipment 11, such as a personal computer. Into the housing of this fuel cell unit 100 are incorporated a DMFC unit 200 and a control unit 201 in addition to the power supply control unit 110.

The DMFC unit 200 includes the fuel cell (fuel cell stack) 1, a fuel tank 101, and auxiliary equipment 102. The auxiliary equipment is comprised of a mixing tank, a pump, and so on. The control unit 201 is adapted to control the operation of the DMFC unit 200 and the DC/DC converter 2. The control unit 201 sets input power of the DC/DC converter 2 in accordance with the operating conditions of the DMFC unit 200.

The output power of the second DC/DC converter 10 is supplied to the electronic equipment 11 as operating power. The electronic equipment includes a main body 51 and a power supply circuit 52. The power supply circuit produces power to be supplied to each component comprising the main body from power received from the second DC/DC converter 10.

As described above, according to this embodiment, in the arrangement in which the output of the DC/DC converter 2 coupled to the fuel cell 1 and the output of the secondary battery 7 are connected in the diode OR configuration, the shorting FETs 5 and 6 are connected in parallel with the diodes 3 and 4, respectively. Each of the FETs is on/off controlled on the basis of the relation between the output voltage of the secondary battery 7 and the output voltage of the DC/DC converter 2. Thereby, diode-based loss can be reduced considerably, thus allowing the fuel cell 1 and the secondary battery 7 to be used in combination and the power loss to be reduced sufficiently.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply apparatus comprising:
a DC to DC converter coupled to an output of a fuel cell, comprising a characteristic that an output voltage of the DC to DC converter drops in accordance with an increase of an output current of the DC to DC converter;
a first diode connected between the output of the DC to DC converter and an output terminal of the apparatus;
a second diode connected between an output of a secondary battery and the output terminal, the second diode comprising a forward voltage drop substantially equal to a forward voltage drop of the first diode;
a first transistor comprising a current path connected in parallel with the first diode;
a second transistor comprising a current path connected in parallel with the second diode; and
a controller configured to monitor the output voltage of the DC to DC converter and the output voltage of the secondary battery, to set the first and the second transistor to the off and the on state respectively when the output voltage of the DC to DC converter is equal to or lower than a reference voltage which is the sum of the output voltage of the secondary battery and a given offset voltage, and to set the first and the second transistor to the on and the off state respectively when the output voltage of the DC to DC converter is higher than the reference voltage, the offset voltage being equal to the forward voltage drop or higher than the forward voltage drop by a given value.

2. The apparatus of claim 1, wherein the output voltage of the DC to DC converter is higher than the output voltage of the secondary battery when the output current of the DC to DC converter is equal to or lower than a given value.

3. The apparatus of claim 2, wherein the controller is configured to switch the second transistor from the off state to the on state after switching the first transistor from the on state to the off state in order to temporarily set both the first and second transistors to the off state when the output voltage of the DC to DC converter falls to or below the reference voltage while the first and the second transistor have been set to the on and the off state, respectively.

4. The apparatus of claim 3, wherein the controller is configured to switch the first transistor from the off state to the on state after switching the second transistor from the on state to the off state in order to temporarily set both the first and second transistors to the off state when the output voltage of the DC to DC converter becomes higher than the reference voltage while the first and the second transistor have been set to the off and the on state, respectively.

5. The apparatus of claim 1, further comprising a charging circuit coupled to the output terminal and configured to charge the secondary battery, and wherein the controller is configured to operate the charging circuit when the output voltage of the DC to DC converter is a given value higher than the reference voltage.

6. The apparatus of claim 1, further comprising an additional DC to DC converter coupled to the output terminal, configured to convert the voltage of the output terminal to a target output voltage.

7. A fuel cell apparatus configured to supply power to electronic equipment, comprising:
a fuel cell:
a secondary battery;
a first DC to DC converter coupled to an output of the fuel cell, and comprising a characteristic that an output voltage of the first DC to DC converter drops in accordance with an increase of an output current of the first DC to DC converter;
a first diode connected between the output of the first DC to DC converter and a power output terminal;
a second diode connected between an output of the secondary battery and the power output terminal, the second diode comprising a forward voltage drop substantially equal to a forward voltage drop of the first diode;
a first transistor comprising a current path connected in parallel with the first diode;
a second transistor comprising a current path connected in parallel with the second diode;
a second DC to DC converter coupled to the power output terminal, configured to convert the voltage on the power output terminal to a target output voltage to be supplied to the electronic equipment; and
a controller configured to monitor the output voltage of the first DC to DC converter and the output voltage of the secondary battery, to set the first and the second transistor to the off and the on state respectively when the output voltage of the first DC to DC converter is equal to or lower than a reference voltage which is the sum of the output voltage of the secondary battery and a given offset voltage, and to set the first and the second transistor to the on and the off state respectively when the output voltage of the first DC to DC converter is higher than the reference voltage, the offset voltage being equal to the forward voltage drop or higher than the forward voltage drop by a given value.

8. The fuel cell apparatus of claim 7, wherein the output voltage of the first DC to DC converter is higher than the output voltage of the secondary battery when the output current of the first DC to DC converter is equal to or lower than a given value.

9. A method of controlling an operation of a power supply apparatus comprising a DC to DC converter coupled to an output of a fuel cell and comprising a characteristic that an output voltage of the DC to DC converter drops in accordance with an increase of an output current of the DC to DC converter, a first diode connected between the output of the DC to DC converter and an output terminal of the apparatus, and a second diode connected between an output of a secondary battery and the output terminal, the second diode comprising a forward voltage drop substantially equal to a forward voltage drop of the first diode, the method comprising:
monitoring the output voltage of the DC to DC converter and the output voltage of the secondary battery;
switching a first transistor comprising a current path connected in parallel with the first diode from the on state to the off state and a second transistor comprising a current path connected in parallel with the second diode from the off state to the on state when the output voltage of the DC to DC converter falls to or below a reference voltage which is the sum of the output voltage of the secondary voltage and a given offset voltage which is equal to the forward voltage drop or higher than the forward voltage drop by a given value; and
switching the first transistor from the off state to the on state and the second transistor from the on state to the off state when the output voltage of the DC to DC converter goes higher than the reference voltage.

10. The method of claim 9, wherein the output voltage of the DC to DC converter is higher than the output voltage of the secondary battery when the output current of the DC to DC converter is equal to or lower than a given value.
